(19) United States
(12) Patent Application Publication
(10) Pub. No.: US 2024/0403027 A1
(43) Pub. Date: Dec. 5, 2024

(54) IN-VEHICLE DEVICE, PROGRAM, AND METHOD FOR UPDATING PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Takayuki SHIOZAWA, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 18/699,675

(22) PCT Filed: Sep. 27, 2022
(86) PCT No.: PCT/JP2022/035814

§ 371 Date: Apr. 9, 2024

(30) Foreign Application Priority Data
Oct. 12, 2021 (JP) 2021-167466

(51) Int. Cl. G06F 8/65

(52) U.S. Cl. CPC G06F 8/65

(57) ABSTRACT

Provided is an in-vehicle device obtains an update program transmitted from an external server outside a vehicle and performs processing for updating a program of an in-vehicle ECU mounted in the vehicle. The in-vehicle device includes a control unit configured to perform processing related to the update program, wherein the control unit obtains, from the external server, an operation check scenario for performing operation check of an in-vehicle ECU to be updated when obtaining the update program, outputs, to the in-vehicle ECU to be updated, the obtained update program and operation check scenario, and performs processing related to the operation check of the in-vehicle ECU to be updated, based on the operation check scenario.

### CROSS-REFERENCE TO RELATED APPLICATIONS

This application is the U.S. national stage of PCT/JP2022/035814 filed on Sep. 27, 2022, which claims priority of Japanese Patent Application No. JP 2021-167466 filed on Oct. 12, 2021, the contents of which are incorporated herein.

### TECHNICAL FIELD

The present disclosure relates to an in-vehicle device, a program, and a method for updating a program.

### BACKGROUND

A vehicle is equipped with ECUs (Electronic Control Units) for controlling in-vehicle devices such as devices of a drive control system for controlling an engine and the like, and a body system for controlling an air conditioner and the like. The ECUs each include a computational processing unit such as an MPU, a rewritable nonvolatile storage unit such as a RAM, and a communication unit for communicating with other ECUs, and controls the in-vehicle devices by loading and executing a control program stored in a storage unit. Furthermore, a communication device having a wireless communication function is mounted in the vehicle, and the vehicle can communicate with a program providing device connected to a network outside the vehicle via the communication device, download (receive) a control program for an ECU from the program providing device, and update the control program of the ECU (for example, see JP 2017-97851A).

The communication device (relay device) disclosed in JP 2017-97851A has a problem in that, prior to the downloaded control program being applied to the ECU to be updated, checking that the ECU will be operational when the control program is applied to the ECU is not considered.

An object of the present disclosure is to provide, for example, an in-vehicle device capable of efficiently checking the operation of an in-vehicle ECU to which a program is applied, prior to performing processing for updating the program of the in-vehicle ECU.

### SUMMARY

An in-vehicle device according to an aspect of the present disclosure is an in-vehicle device that obtains an update program transmitted from an external server outside a vehicle and performs processing for updating a program of an in-vehicle ECU mounted in the vehicle, the in-vehicle device including a control unit configured to perform processing related to the update program, wherein the control unit obtains, from the external server, an operation check scenario for performing an operation check of an in-vehicle ECU to be updated when obtaining the update program, outputs, to the in-vehicle ECU to be updated, the obtained update program and operation check scenario, and performs processing related to the operation check of the in-vehicle ECU to be updated, based on the operation check scenario.

### Advantageous Effects of Present Disclosure

According to an aspect of the present disclosure, it is possible to provide, for example, an in-vehicle device that efficiently performs an operation check of an in-vehicle ECU to which a program is applied, prior to performing processing for updating the program of the in-vehicle ECU.

### BRIEF DESCRIPTION OF DRAWINGS

FIG. 1 is a schematic view illustrating the configuration of an in-vehicle update system including an in-vehicle device according to a first embodiment.

FIG. 2 is a block diagram illustrating a physical configuration of the in-vehicle device.

FIG. 3 is an explanatory diagram illustrating a flow (sequence) of processing performed by the in-vehicle device, the in-vehicle ECU to be updated, and the like.

FIG. 4 is a flowchart illustrating processing performed by a control unit of the in-vehicle device.

FIG. 5 is a flowchart illustrating processing performed by a control unit of an in-vehicle device according to a second embodiment.

### DETAILED DESCRIPTION OF PREFERRED EMBODIMENTS

First, embodiments of the present disclosure will be listed and described. Note that at least some of the embodiments described below may be combined with each other as appropriate.

An in-vehicle device according to an aspect of the present disclosure is an in-vehicle device that obtains an update program transmitted from an external server outside a vehicle and performs processing for updating a program of an in-vehicle ECU mounted in the vehicle, the in-vehicle device including a control unit configured to perform processing related to the update program, wherein the control unit obtains, from the external server, an operation check scenario for performing an operation check of in-vehicle ECU to be updated when obtaining the update program, outputs, to the in-vehicle ECU to be updated, the obtained update program and operation check scenario, and performs processing related to the operation check of the in-vehicle ECU to be updated, based on the operation check scenario.

In the present aspect, the in-vehicle device (control unit) outputs the update program and the operation check scenario to the in-vehicle ECU to be updated, and performs processing related to the operation check of the in-vehicle ECU to be updated, based on the operation check scenario. The operation check scenario includes, for example, an execution procedure of a processing sequence, a script, or a command for the operation check performed by the in-vehicle device with respect to the in-vehicle ECU to be updated. The in-vehicle ECU (in-vehicle ECU to be updated) that has obtained the update program and the operation check scenario from the in-vehicle device applies the obtained update program, and then performs processing related to the operation check, based on the operation check scenario obtained together with the update program. With this configuration, the in-vehicle ECU to be updated and the in-vehicle device can perform the operation check of the in-vehicle ECU to which the update program is applied (in-vehicle ECU to be updated), based on the same operation check scenario, and can efficiently check the operation of the in-vehicle ECU to be updated in the actual environment of the vehicle in which the in-vehicle ECU and the in-vehicle device are mounted.

In the in-vehicle device according to an aspect of the present disclosure, the control unit may substitute for another in-vehicle ECU other than the in-vehicle ECU to be updated, based on the operation check scenario, and perform the processing related to the operation check of the in-vehicle ECU to be updated.

In the present aspect, the in-vehicle device substitutes for the in-vehicle ECU other than the in-vehicle ECU to be updated, and performs the processing related to the operation check of the in-vehicle ECU to be updated, and thus it is possible to efficiently perform the operation check in accordance with the actual environment of the vehicle.

In the in-vehicle device according to an aspect of the present disclosure, the operation check scenario includes a processing sequence in which the control unit that substitutes for the other in-vehicle ECU transmits data to the in-vehicle ECU to be updated, and a processing sequence in which the in-vehicle ECU to be updated to which the update program is applied transmits data to the other in-vehicle ECU substituted by the control unit.

In the present aspect, the operation check scenario includes a processing sequence in which data transmission and reception between the in-vehicle device that substitutes for the other in-vehicle ECU and the in-vehicle ECU to which the update program has been applied (in-vehicle ECU to be updated) is defined, and thus it is possible to efficiently perform the operation check in accordance with the actual environment of the vehicle. In other words, the in-vehicle ECU to which the update program has been applied attempts to transmit and receive data to and from the other in-vehicle ECU, based on the operation check scenario, but the transmission and reception of the data are performed by the in-vehicle device that substitutes for the other in-vehicle ECU. With this configuration, the in-vehicle ECU to which the update program has been applied performs the operation check in accordance with the actual operation (actual vehicle environment) in the vehicle, but actually, the in-vehicle device that substitutes for the other in-vehicle ECU responds based on the operation check scenario. As a result, by performing the operation check, the operation check of the in-vehicle ECU to which the update program has been applied can be efficiently performed, without affecting the control of the vehicle.

In the in-vehicle device according to an aspect of the present disclosure, the operation check scenario includes determination information for determining a result of the operation check of the in-vehicle ECU to be updated, the control unit performs the processing related to the operation check of the in-vehicle ECU to be updated and obtains a result of the operation check, and determines whether or not the program update in the in-vehicle ECU to be updated has succeeded, based on the obtained result of the operation check and the determination information included in the operation check scenario.

In the present aspect, the operation check scenario includes determination information for determining a result of the operation check of the in-vehicle ECU to be updated. The determination information includes, for example, the type of data expected to be transmitted from the in-vehicle ECU to be updated, a transmission cycle, an expected usage rate of a CPU or a memory of the in-vehicle ECU, and an expected value of a reply response when data for the operation check is transmitted from the in-vehicle device. The in-vehicle device (control unit) can efficiently determine whether or not the program update in the in-vehicle ECU to be updated has succeeded, by comparing the determination information included in the operation check scenario with various values and the like included in the result of the operation check.

In the in-vehicle device according to an aspect of the present disclosure, the control unit obtains, from the in-vehicle ECU to be updated, a result of a stand-alone diagnosis performed by the in-vehicle ECU to be updated based on the operation check scenario, and determines whether or not the program update in the in-vehicle ECU to be updated has succeeded, based on the obtained result of the stand-alone diagnosis.

In the present aspect, the in-vehicle ECU performs the self-diagnosis processing internally based on the check scenario obtained from the in-vehicle device. The self-diagnosis processing is a diagnosis processing performed without communicating with another in-vehicle ECU such as an in-vehicle device, and corresponds to a stand-alone diagnosis. With this configuration, the in-vehicle device obtains the result of the stand-alone diagnosis from the in-vehicle ECU to be updated, and determines whether or not the program update in the in-vehicle ECU to be updated has succeeded based on the result of the stand-alone diagnosis, and thus it is possible to efficiently determine whether or not the program update in the in-vehicle ECU to be updated is successful.

In the in-vehicle device according to the aspect of the present disclosure, the control unit enhances the operation check scenario obtained from the external server using a relay log collected when processing for relaying communication between a plurality of in-vehicle ECUs mounted in the vehicle is performed, outputs the obtained update program and the enhanced operation check scenario to the in-vehicle ECU to be updated, and performs the processing related to the operation check of the in-vehicle ECU to be updated, based on the enhanced operation check scenario.

In the present aspect, the in-vehicle device functions as an in-vehicle relay device such as a gateway or an Ethernet SW that performs relay processing for relaying communication between the plurality of in-vehicle ECUs mounted in the vehicle. The in-vehicle device functioning as the in-vehicle relay device stores, in a storage unit, a relay log collected when performing the relay processing, and the relay log includes, for example, header information (source address, destination address, message IDs, and the like), payload information, and transmission/reception frequency, or cycle of Ethernet frames or CAN messages that are relayed. The in-vehicle device (control unit) enhances the operation check scenario obtained from the external server through addition or the like by using the relay logs stored in the storage unit, for example, and thus can further adapt the operation check scenario to the actual environment of the vehicle. By using the operation check scenario (enhanced operation check scenario) in which the adaptability with the actual environment of the vehicle is improved in this manner, it is possible to improve the accuracy of the operation check with respect to the in-vehicle ECU to be updated.

In the in-vehicle device according to the aspect of the present disclosure, when an IG (ignition) switch of the vehicle is turned off, the control unit performs the processing related to the operation check of the in-vehicle ECU to be updated, based on the operation check scenario.

In the present aspect, the in-vehicle device performs the processing related to the operation check based on the operation check scenario after the IG switch of the vehicle is turned off, and thus can perform the processing related to the operation check without being affected by the other in-vehicle ECUs that are driven only when the IG switch is turned on, and also without affecting the other in-vehicle ECUs.

In the in-vehicle device according to the aspect of the present disclosure, the control unit outputs, to the other in-vehicle ECUs other than the in-vehicle ECU to be updated, a sleep signal for transitioning to a sleep mode, and, after outputting the sleep signal, performs the processing related to the operation check for the in-vehicle ECU to be updated, based on the operation check scenario.

In the present aspect, after outputting the sleep signal to the other in-vehicle ECUs other than the in-vehicle ECU to be updated, the in-vehicle device performs the processing related to the operation check based on the operation check scenario. With this configuration, the other in-vehicle ECUs transition to the sleep mode in which the processing related to data transmission and reception is not performed, and therefore, the in-vehicle device can perform the processing related to operation check without being affected by the other in-vehicle ECUs, and also without affecting the other in-vehicle ECUs.

A program according to an aspect of the present disclosure causes a computer configured to obtains an update program transmitted from an external server outside a vehicle and performs processing for updating a program of an in-vehicle ECU mounted in the vehicle to execute processing for obtaining, from the external server, an operation check scenario for performing an operation check of the in-vehicle ECU to be updated when obtaining the update program, outputting, to the in-vehicle ECU to be updated, the obtained update program and operation check scenario, and performing processing related to the operation check of the in-vehicle ECU to be updated, based on the operation check scenario.

In the present aspect, the computer can be caused to function as an in-vehicle device that efficiently performs an operation check of the in-vehicle ECU to which the control program has been applied, prior to performing processing for updating the control program of the in-vehicle ECU.

A method for updating a program according to an aspect of the present disclosure causes a computer that obtains an update program transmitted from an external server outside a vehicle and performs processing for updating a program of an in-vehicle ECU mounted in the vehicle to execute processing for obtaining, from the external server, an operation check scenario for performing an operation check of the in-vehicle ECU to be updated when obtaining the update program, outputting, to the in-vehicle ECU to be updated, the obtained update program and operation check scenario, and performing processing related to the operation check of the in-vehicle ECU to be updated, based on the operation check scenario.

In the present aspect, it is possible to provide a method for updating a program for efficiently performing an operation check of an in-vehicle ECU to which a control program has been applied, prior to performing processing for updating the control program of the in-vehicle ECU.

The present disclosure will be described in detail with reference to the drawings illustrating embodiments thereof. An in-vehicle device 2 according to the embodiments of the present disclosure will be described below with reference to the drawings. It should be noted that the present disclosure is not limited to these examples, but rather is indicated by the claims, and all changes which come within the meaning and range of equivalency of the claims are intended to be embraced therein.

### First Embodiment

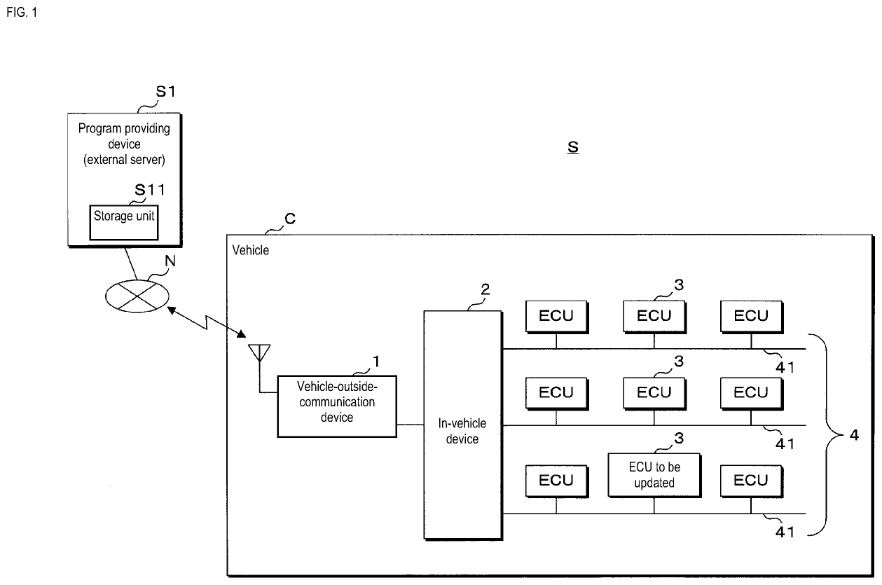

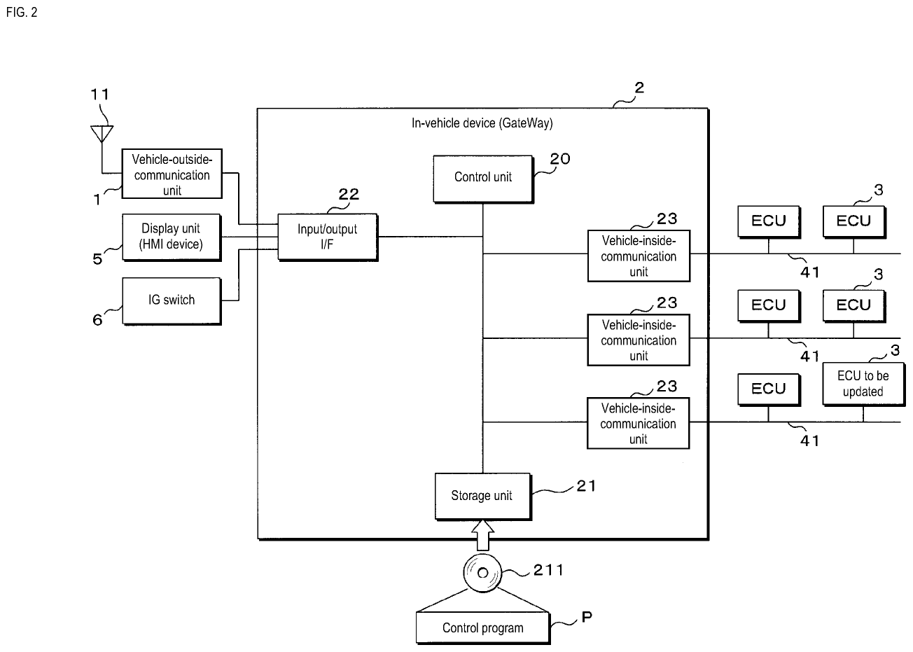

The following describes the embodiments based on the drawings. FIG. 1 is a schematic view illustrating a configuration of an in-vehicle update system S according to a first embodiment. FIG. 2 is a block diagram illustrating a configuration of an in-vehicle device 2 and the like. The in-vehicle update system S includes a vehicle-outside-communication device 1 and the in-vehicle device 2, which are mounted in a vehicle C, and transmits a package (an update program and an operation check scenario) obtained from a program providing device S1 connected to the in-vehicle update system S via an external network N to in-vehicle ECUs 3 (Electronic Control Units) mounted in the vehicle C.

The program providing device S1 is a computer such as a server connected to the external network N such as the Internet, or a public network, includes a storage unit S11 constituted by a RAM (Random Access Memory), a ROM (Read Only Memory), a hard disk, or the like, and corresponds to an external server outside the vehicle. A program or data created by the manufacturer or the like of the in-vehicle ECUs 3 for controlling the in-vehicle ECUs 3 is stored in the storage unit S11 of the program providing device S1. The program or data is transmitted to the vehicle C as an update program, as described later, and used to update the program or data of the in-vehicle ECUs 3 mounted in the vehicle C. The program providing device S1 (external server) configured as described above is also referred to as an OTA (Over The Air) server. The in-vehicle ECUs 3 to be mounted in the vehicle obtain the update program transmitted from the program providing device S1 through wireless communication, and apply the update program as the program to be executed, and thus the ECUs can update (reprogram) the program to be executed by the ECUs.

In the following description, the program is assumed to include an external file in which program code including control syntaxes and the like for performing processing by the in-vehicle ECUs 3 and data that is referred to when executing the program code are described. When transmitting the update program, the external file in which the program code and the data are described is transmitted from the program providing device S1 as an encoded archive file, for example. When transmitting the update program, the program providing device S1 creates a package including the update program, and transmits the created package to the vehicle C. The package includes, for example, package information (campaign information), which is information related to program update, information (target information) related to an in-vehicle ECU to be updated, an update program to be applied to the in-vehicle ECU to be updated, and an operation check scenario for performing an operation check when the update program is applied to the in-vehicle ECU.

The vehicle-outside-communication device 1, the in-vehicle device 2, a display device 5, and the plurality of in-vehicle ECUs 3 for controlling various in-vehicle apparatuses are mounted in the vehicle C. The vehicle-outside-communication device 1 and the in-vehicle device 2 are communicably connected to each other by a harness such as a serial cable. The in-vehicle device 2 and the in-vehicle ECUs 3 are communicably connected to each other via a vehicle-inside LAN 4 compatible with a communication protocol such as CAN (Control Area Network/registered trademark) or Ethernet (registered trademark).

The vehicle-outside-communication device 1 includes a vehicle-outside-communication unit (not shown) and an input/output I/F (interface) (not shown) for communicating with the in-vehicle device 2. The vehicle-outside-communication unit is a communication device for performing wireless communication using a mobile communication protocol such as 3G, LTE, 4G, 5G, or Wi-Fi, and transmits and receives data to and from the program providing device S1 via an antenna 11 connected to the vehicle-outside-communication unit. The communication between the vehicle-outside-communication device 1 and the program providing device S1 is performed through an external network such as a public network or the Internet.

An input/output I/F of the vehicle-outside-communication device 1 is a communication interface for performing serial communication with the in-vehicle device 2, for example. The vehicle-outside-communication device 1 and the in-vehicle device 2 communicate with each other through a harness such as a serial cable connected to the input/output I/F. In the present embodiment, the vehicle-outside-communication device 1 is a device separate from the in-vehicle device 2, and these devices are communicably connected to each other through the input/output I/F and the like, but the present disclosure is not limited to this configuration. The vehicle-outside-communication device 1 may also be built into the in-vehicle device 2 as a constituent part of the in-vehicle device 2.

The in-vehicle device 2 includes a control unit 20, a storage unit 21, and vehicle-inside-communication units 23. The in-vehicle device 2 is configured to obtain, from the vehicle-outside-communication device 1, the update program (package) received by the vehicle-outside-communication device 1 from the program providing device S1 through wireless communication, and transmit the update program to a predetermined in-vehicle ECU 3 (in-vehicle ECU 3 to be updated) through the vehicle-inside LAN 4. In other words, the in-vehicle device 2 functions as an OTA master that controls the program update in the in-vehicle ECU 3 to be updated.

The in-vehicle device 2 is, for example, a gateway (in-vehicle relay device) that controls buses (segments) of a plurality of systems such as in-vehicle ECUs 3 of a control system, in-vehicle ECUs 3 of a safety system, and in-vehicle ECUs 3 of a body system, and relays communication between the in-vehicle ECUs 3 through the buses (segments). In other words, the in-vehicle device 2 functions as a CAN gateway in relay according to the CAN protocol, and functions as a layer 2 switch or a layer 3 switch in relay according to the TCP/IP protocol. The in-vehicle device 2 may be a PLB (Power Lan Box) that also functions as a power distribution device that distributes and relays power output from a power supply device such as a secondary battery, and supplies power to in-vehicle devices such as actuators connected to the in-vehicle device 2, in addition to relaying power related to communication. Alternatively, the in-vehicle device 2 may also be configured as a functional unit of a body ECU that performs overall control of the vehicle C. Furthermore, the in-vehicle device 2 may also be an integrated ECU that includes a central processing unit (control unit) such as a vehicle computer, and that performs overall control of the vehicle.

The control unit 20 is configured, for example, by a CPU (Central Processing Unit), an MPU (Micro Processing Unit), and performs various control processes, arithmetic processes, and the like by loading and executing a control program P (program product) and data stored in advance in the storage unit 21.

The storage unit 21 is configured by a volatile memory element such as a RAM (Random Access Memory) or a nonvolatile memory element such as a ROM (Read Only Memory), an EEPROM (Electrically Erasable Programmable ROM), or a flash memory, and stores a control program and data to be referred to during the processing in advance. A control program P (program product) stored in the storage unit 21 may be a control program P (program product) that has been read from a recording medium 211 that is readable by the in-vehicle device 2. Also, the control program P may be a control program that is downloaded from an external computer (not shown) connected to a communication network (not shown), and that is stored in the storage unit 21.

Furthermore, the storage unit 21 stores vehicle configuration information in which pieces of configuration information of the respective in-vehicle ECUs mounted in the vehicle are aggregated. The vehicle configuration information includes, for example, serial numbers of the respective in-vehicle ECUs, ECU part numbers (model numbers), software part numbers, current versions of the programs, old versions of the programs, the number of operation planes, operation planes, MAC (Media Access Control) addresses, IP addresses, a date and time of completion of the previous update, reprogram statuses, and a VIN (Vehicle Identification Number)/vehicle identification number (VIN).

The storage unit 21 stores relay route information (routing table) used for performing processing for relaying communication between the in-vehicle ECUs 3 or communication between any of the in-vehicle ECUs 3 and the external server 100. The format of the relay route information is determined based on the communication protocol. When the communication protocol is CAN, the relay route information for CAN includes a message identifier (CAN-ID) included in the CAN message and a relay destination (I/O port number of the CAN communication unit 232) associated with the CAN-ID. When the communication protocol is TCP/IP, the TCP/IP-based relay route information includes a transmission destination address (MAC address or IP address) included in the IP packet and a relay destination (physical port number of the Ethernet communication unit 231) associated with the transmission destination address. The relay route information (routing table) may also be included in the vehicle configuration information.

The storage unit 21 further stores relay logs that are collected when processing for relaying communication between the plurality of in-vehicle ECUs is performed. The relay logs each include data such as header information (source address, destination address, message IDs, and the like), payload information, and transmission/reception frequency or cycle of Ethernet frames or CAN messages that are relayed, for example, and the data may also be associated with a time stamp indicating a communication history. With this configuration, the relay logs can be used as data indicating a communication state and a communication history in an actual operation environment (actual vehicle environment) of a vehicle in which the in-vehicle device is mounted.

Similarly to the input/output I/F of the vehicle-outside-communication device 1, an input/output I/F 22 is a communication interface for performing serial communication, for example. The in-vehicle device 2 is communicably connected, via the input/output I/F 22, to the vehicle-outside-communication device 1, the display device 5 (HMI device), and the IG switch 6 for starting and stopping the vehicle C.

The vehicle-inside-communication units 23 are each an input/output interface (CAN transmitter/receiver, Ethernet PHY unit) using communication protocol of, for example, CAN (Control Area Network), CAN-FD (CAN with Flexible Data Rate), or Ethernet (registered trademark), and function as a communication unit for the in-vehicle device 2 and the in-vehicle ECUs 3 to communicate with each other. The in-vehicle device 2 is provided with a plurality of vehicle-inside-communication units 23, and a plurality of communication lines 41 (Ethernet cables and CAN buses) constituting the in-vehicle network 4, that is, a plurality of buses are connected to the plurality of vehicle-inside-communication units 23, respectively. By providing the vehicle-inside-communication units 23 in this manner, the in-vehicle network 4 may be divided into a plurality of buses (segments), and the in-vehicle ECUs 3 may be respectively connected to the segments according to the function of the in-vehicle ECUs 3. The control unit 20 of the in-vehicle device 2 communicates with the in-vehicle ECUs 3 connected to the in-vehicle network 4 through the vehicle-inside-communication units 23.

Similarly to the in-vehicle device 2, the in-vehicle ECUs 3 each include a control unit (not shown), a storage unit (not shown), and a vehicle-inside-communication unit (not shown). The storage unit is constituted by a volatile memory device such as a RAM (Random Access Memory) or a non-volatile memory device such as a ROM (Read Only Memory), an EEPROM (Electrically Erasable Programmable ROM), or a flash memory, and stores a program or data of the in-vehicle ECU 3. The program or data is to be updated by an update program transmitted from the program providing device and relayed by the in-vehicle device 2. Similarly to the in-vehicle device 2, the vehicle-inside-communication unit of each of the in-vehicle ECUs 3 is configured by, for example, a CAN transmitter/receiver or an Ethernet PHY unit, and communicates with the in-vehicle device 2 through the vehicle-inside-communication units.

The display device 5 is an HMI (Human Machine Interface) device such as a display of a car navigation system, for example. The display device 5 is communicably connected to an input/output I/F 22 of the in-vehicle device 2 through a harness such as a serial cable. The display device 5 displays data or information that is output from the control unit 20 of the in-vehicle device 2 through the input/output I/F 22.

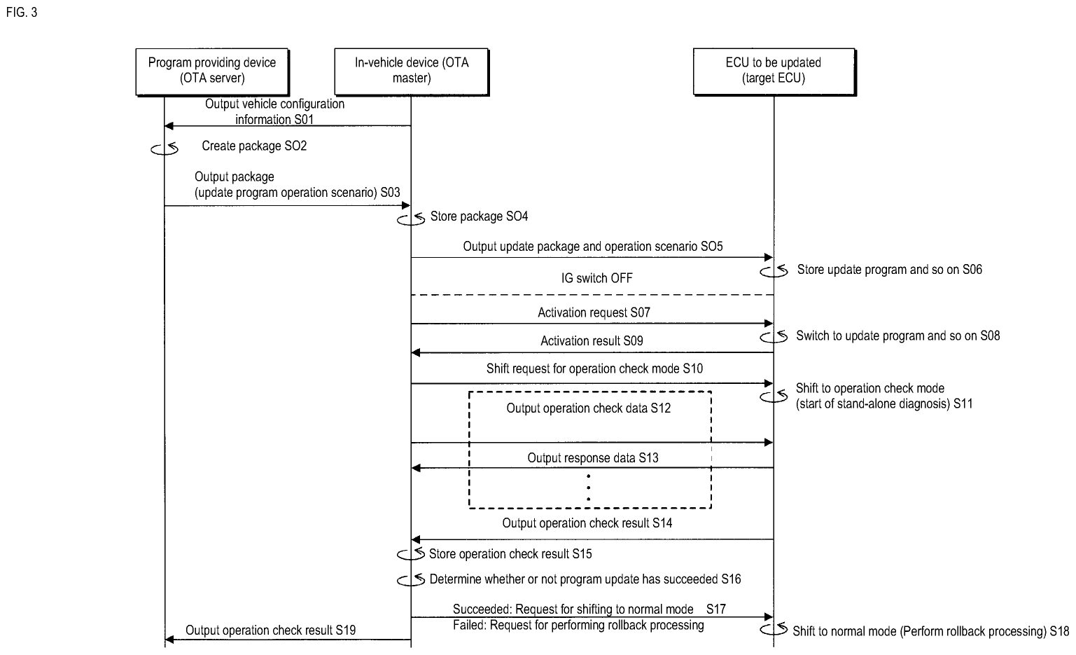

FIG. 3 is an explanatory diagram exemplifying a flow (sequence) of processing executed by the in-vehicle device 2, the in-vehicle ECU 3 to be updated, and the like. Regarding the processing of updating the program of the in-vehicle ECU 3 to be updated using the update program, the processing sequences of the program providing device S1 (OTA server), the in-vehicle device 2 (OTA master), and the in-vehicle ECU 3 to be updated (target ECU) will be described.

The in-vehicle device 2 outputs (transmits) the vehicle configuration information of the vehicle C to the program providing device S1 (step S01). The in-vehicle device 2 constantly obtains, from the in-vehicle ECUs 3, program information, model information, and the like applied to the in-vehicle ECUs 3, and creates and stores the vehicle configuration information by aggregating these pieces of information. The in-vehicle device 2 may include, in the vehicle configuration information, a VIN (Vehicle Identification Number).

The program providing device S1 creates a package including the update program and the operation check scenario (step S02). The program providing device S1 creates the package, based on the vehicle configuration information obtained from the in-vehicle device 2. The package includes package information (campaign information), which is information related to the program update, information (target information) related to the in-vehicle ECU 3 to be updated, an update program to be applied to the in-vehicle ECU 3 to be updated, and an operation check scenario for performing an operation check when the update program is applied to the in-vehicle ECU 3. The operation check scenario includes, for example, execution procedures of a processing sequence, a script, or a command for the operation check performed by the in-vehicle device 2 with respect to the in-vehicle ECU 3 to be updated. The operation check scenario further includes a processing sequence for the operation check performed by the in-vehicle ECU 3 to be updated, and determination information for verifying (determining success or failure of the update) a result of the operation check performed by the in-vehicle device 2 and the in-vehicle ECU 3 to be updated. The program providing device S1 can create an operation check scenario according to the actual environment of the vehicle C in which the in-vehicle device 2 is mounted, based on the vehicle configuration information transmitted from the in-vehicle device 2. The program providing device S1 outputs (transmits) the created package to the in-vehicle device 2 (step S03).

The in-vehicle device 2 stores the package obtained (received) from the program providing device S1 in the storage unit S11 (step S04). The in-vehicle device 2 may be configured to shift (transition) from the normal mode (the state during the normal operation of the vehicle C) to the update mode, by obtaining the package from the program providing device S1. The in-vehicle device 2 outputs (transmits), to the in-vehicle ECU 3 to be updated, the update program and the operation check scenario included in the package (step S05).

The in-vehicle ECU 3 to be updated stores, in the storage unit, the update program and the operation check scenario obtained (received) from the in-vehicle device 2 (step S06). The in-vehicle ECU 3 to be updated shifts (transitions) to the update mode, by receiving the update program and the operation check scenario from the in-vehicle device 2.

The storage unit of the in-vehicle ECU 3 to be updated includes a first storage area in which a program (current version of program) that is being applied at the present time is stored and a second storage area in which a program (old version of program) that was applied in the past is stored. The in-vehicle ECU 3 to be updated may also be configured to store the update program and the operation check scenario obtained from the in-vehicle device 2 in the second storage area, thereby saving (storing) the update program and the like without overwriting the current version of program stored in the first storage area. The in-vehicle ECU 3 to be updated includes the storage unit having two storage areas, that is, the first storage area and a second storage area, and thus can reliably perform rollback processing for returning to the old version of program.

After the IG switch 6 of the vehicle C is turned off, the in-vehicle device 2 makes an activation request (an instruction to apply the update program) to the in-vehicle ECU 3 to be updated (step S07). After the IG switch 6 of the vehicle C is turned off, the in-vehicle device 2 transmits a control signal (activation request signal) to the in-vehicle ECU 3 to be updated, for example, and makes an activation request (instruction to apply the update program) to the in-vehicle ECU 3 to be updated. The trigger of the activation request is turning off of the IG switch 6, but the present disclosure is not limited thereto, and the in-vehicle device 2 may also make an activation request to the in-vehicle ECU 3 to be updated, by using preset scheduling information, a multicast of a sleep signal, or the like as the trigger.

The in-vehicle ECU 3 to be updated switches the applied program from the current program to the update program, in response to receiving the activation request from the in-vehicle device 2 (step S08). The in-vehicle ECU 3 to be updated outputs (transmits), to the in-vehicle device 2, information (activation result) indicating that the applied program has been switched to the update program (step S09). As described above, the in-vehicle ECU 3 to be updated includes the storage unit having the first storage area and the second storage area, and sets the applied program to the update program, by validating (activating) the second storage area in which the update program is stored.

The in-vehicle device 2 requests the in-vehicle ECU 3 to be updated to shift to the operation check mode, in accordance with the operation check scenario stored in the storage unit 21 (step S10). The in-vehicle device 2 transmits a control signal (operation-check-mode shift signal) to the in-vehicle ECU 3 to be updated, for example, to request the in-vehicle ECU 3 to be updated to shift to the operation check mode.

The in-vehicle ECU 3 to be updated shifts (transitions) to the operation check mode, in response to receiving the request to shift to the operation check mode from the in-vehicle device 2 (step S11). The in-vehicle ECU 3 to be updated that has shifted to the operation check mode executes the update program, based on the operation check scenario. The operation check scenario includes a sequence related to self-diagnosis processing (stand-alone diagnosis) performed in the in-vehicle ECU 3 to be updated. The in-vehicle ECU 3 to be updated that has shifted to the operation check mode performs self-diagnosis processing (stand-alone diagnosis), based on the operation check scenario.

The in-vehicle device 2 outputs (transmits) the operation check data to the in-vehicle ECU 3 to be updated, based on the operation check scenario (step S12). When outputting the operation check data to the in-vehicle ECU 3 to be updated, the in-vehicle device 2 substitutes for another in-vehicle ECU 3 with which the in-vehicle ECU 3 to be updated communicates at normal times. When the in-vehicle device 2 substitutes for the other in-vehicle ECU 3, the in-vehicle device 2 may also transmit an ether frame having the IP address of the other in-vehicle ECU 3 as a source address. Alternatively, when the in-vehicle device 2 substitutes for the other in-vehicle ECU 3, the in-vehicle device 2 may also transmit a CAN message including a CAN-ID to be used by the other in-vehicle ECU 3.

The in-vehicle ECU 3 to be updated outputs (transmits) a response data to the in-vehicle device 2, in response to the operation check data transmitted from the in-vehicle device 2 that substitutes for the other in-vehicle ECU 3 (step S13). The processing sequence by data transmission and reception between the in-vehicle device 2 that substitutes for the other in-vehicle ECU 3 and the in-vehicle ECU 3 to be updated is performed based on the operation check scenario. In the processing sequence, control of sensors or actuators connected to the in-vehicle ECU 3 to be updated may be omitted or invalidated. The in-vehicle device 2 and the in-vehicle ECU 3 to be updated may store a response value in the processing sequence by the data transmission and reception or a measurement value (actual measurement value) of the communication traffic amount or the like, and may save the response value or the measurement value as the operation check result.

The in-vehicle ECU 3 to be updated outputs (transmits), to the in-vehicle device 2, the result of the stand-alone diagnosis and the result of the operation check performed by the data transmission and reception to and from the in-vehicle device 2 (step S14). The operation check scenario includes stand-alone diagnosis determination information for determining the result of the stand-alone diagnosis. The stand-alone diagnosis determination information is an expectation value of a process list, a CPU usage, a memory usage, or the like generated in the in-vehicle ECU 3 to be updated when the update program is executed (activated).

The in-vehicle ECU 3 to be updated determines the result of the stand-alone diagnosis by comparing the various actual measurement values in the result of the stand-alone diagnosis with the various expectation values in the stand-alone diagnosis determination information. When the actual measurement values in the result of the stand-alone diagnosis match the expectation values in the stand-alone diagnosis determination information, the in-vehicle ECU 3 to be updated determines that the result of the stand-alone diagnosis performed based on the operation check scenario is positive (the update of the program has succeeded). When the actual measurement values in the result of the stand-alone diagnosis do not match the expectation values in the stand-alone diagnosis determination information, the in-vehicle ECU 3 to be updated determines that the result of the stand-alone diagnosis performed based on the operation check scenario is negative (the update of the program has failed).

The in-vehicle device 2 stores, in the storage unit 21, the result of the operation check by the data transmission and reception to and from the in-vehicle ECU 3 to be updated (step S15). The in-vehicle device 2 stores, in the storage unit 21, the result of the operation check output from the in-vehicle ECU 3 to be updated. The in-vehicle device 2 also stores, in the storage unit 21, the result of the operation check performed on the in-vehicle device 2.

The in-vehicle device 2 compares the determination information included in the operation check scenario with various values (the measured values and the actual measured values) included in the result of the operation check based on the determination information included in the operation check scenario, and thereby determines whether or not the program update in the in-vehicle ECU 3 to be updated has succeeded (step S16). The determination information includes, for example, expectation values related to response data output from the in-vehicle ECU 3 to be updated in response to operation check data transmitted to the in-vehicle ECU 3 to be updated from the in-vehicle device 2 that substitutes for the other in-vehicle ECU 3. The expectation values related to the response data is, for example, the presence or absence of the response data, type (header information), data length, payload information, and a reply response value to the response data.

In data transmission and reception to and from the in-vehicle ECU 3 to be updated, the in-vehicle device 2 compares the presence or absence of a response output from the in-vehicle ECU 3 to be updated, the length of the response, or the actual measurement values of a reply response value with the determination information (expectation values related to the response) included in the operation check scenario, thereby verifying the result of the operation check. When the response from the in-vehicle ECU 3 to be updated matches the expectation values (expectation values related to the response) defined in the determination information, that is, defined in the operation check scenario, the in-vehicle device 2 determines that the result of the operation check performed based on the operation check scenario is positive (the program update has succeeded). When the response from the in-vehicle ECU 3 to be updated does not match the expectation values (expectation values related to the response) defined in the determination information, that is, defined in the operation check scenario, the in-vehicle device 2 determines that the result of the operation check performed based on the operation check scenario is negative (the program update has failed).

Furthermore, the in-vehicle device 2 determines whether or not the program update in the in-vehicle ECU 3 to be updated has succeeded, based on the result of the stand-alone diagnosis obtained from the in-vehicle ECU 3 to be updated and the result of the operation check by the data transmission and reception to and from the in-vehicle device 2. In other words, the in-vehicle device 2 determines whether or not the program update in the in-vehicle ECU 3 to be updated has succeeded, based on the three check results, that is, the result of the operation check related to the operation check data transmitted and received from and by the in-vehicle device 2, the result of the operation check related to the operation check data transmitted and received from and by the in-vehicle ECU 3, and the result of the stand-alone diagnosis on the in-vehicle ECU 3. When all of the three check results are positive, the in-vehicle device 2 determines that the program in the in-vehicle ECU 3 to be updated has been successfully updated. By obtaining the three check results in the actual vehicle environment, the accuracy of the success or failure determination of the program update can be improved.

If it is determined that the program update has succeeded, the in-vehicle device 2 requests the in-vehicle ECU 3 to be updated to shift to the normal mode (step S17). The in-vehicle ECU 3 to be updated shifts (transitions) to the normal mode in response to receiving the request for shifting to the normal mode from the in-vehicle device 2 (step S18). When the in-vehicle ECU 3 to be updated receives the request for shifting to the normal mode from the in-vehicle device 2, the program update in the in-vehicle ECU 3 to be updated is completed, and the in-vehicle ECU 3 shifts (transitions) to a state (normal mode) in which control in the normal mode is performed when the vehicle C travels or the like.

If at least one of the three check results is negative, the in-vehicle device 2 determines that the program update in the in-vehicle ECU 3 to be updated has failed. If it is determined that the update of the program has failed, the in-vehicle device 2 may request the in-vehicle ECU 3 to be updated to perform the rollback processing. The in-vehicle device 2 may also determine whether the in-vehicle ECU 3 to be updated performs the rollback processing or shifts to a degeneration mode, based on the three check results. The in-vehicle device 2 may also output the fact that the program update has failed to the display device 5, for example, and notify the operator or the like of the vehicle C of the fact.

The in-vehicle device 2 outputs (transmits), to the program providing device S1, the result of the operation check performed based on the operation check scenario (step S19). When the result of the operation check output from the in-vehicle device 2 is obtained, the program providing device S1 stores the result in the storage unit S11. As a result, the information on the program update based on the package can be matched (synchronized) between the in-vehicle device 2 and the program providing device S1.

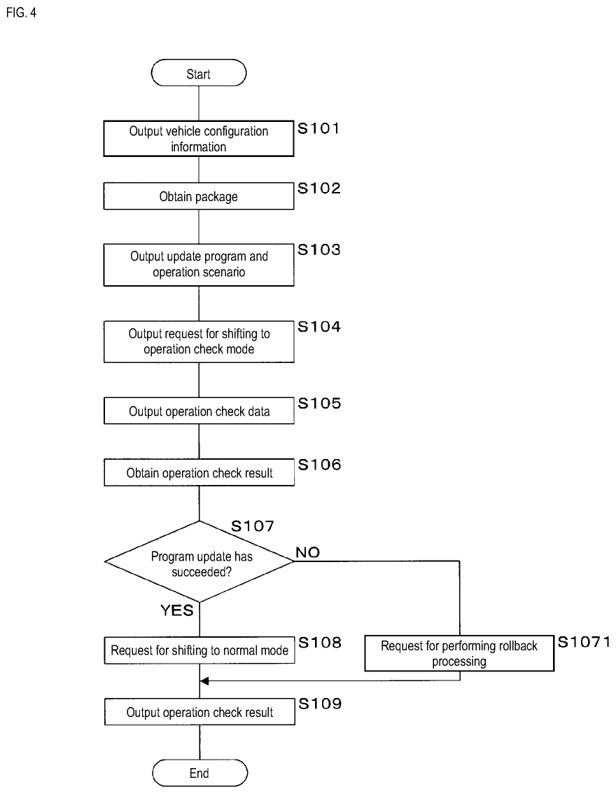

FIG. 4 is a flowchart illustrating processing performed by the control unit 20 of the in-vehicle device 2. The control unit 20 of the in-vehicle device 2 constantly performs the following processing, for example, when the vehicle C is in an activated state (a state in which the IG switch 6 is on).

The control unit 20 of the in-vehicle device 2 outputs (transmits), to the program providing device S1, the vehicle configuration information of the vehicle C (step S101). The output of the vehicle configuration information to the program providing device S1 by the control unit 20 of the in-vehicle device 2 is not limited to the time of performing the program update process on the in-vehicle ECU 3, and may also be performed regularly. In other words, the control unit 20 of the in-vehicle device 2 obtains the applied program information and the type information from all of the in-vehicle ECUs 3 mounted in the vehicle C regularly or periodically, and stores the obtained and aggregated information as the vehicle configuration information. The control unit 20 of the in-vehicle device 2 may also regularly or periodically output (transmit), to the program providing device S1, the vehicle configuration information including the VIN. With this configuration, the program providing device S1 specifies the target vehicle C based on the vehicle configuration information including the VIN, and creates a package corresponding to the specified vehicle C. The package created by the program providing device S1 includes package information (campaign information), which is information related to program update, information (target information) related to the in-vehicle ECU 3 to be updated, an update program (update data), and an operation check scenario.

The control unit 20 of the in-vehicle device 2 obtains, from the program providing device S1, the package including the update program and the operation check scenario (step S102). The control unit 20 of the in-vehicle device 2 communicates with the program providing device S1 via the vehicle-outside-communication device 1, and obtains the package from the program providing device S1. The control unit 20 of the in-vehicle device 2 stores the obtained package in the storage unit 21.

The control unit 20 of the in-vehicle device 2 outputs, to the in-vehicle ECU 3 to be updated, the update program and the operation check scenario (step S103). By outputting the operation check scenario to the in-vehicle ECU 3 to be updated, the operation check scenario is shared between the in-vehicle device 2 and the in-vehicle ECU 3 to be updated. In other words, the in-vehicle device 2 and the in-vehicle ECU 3 to be updated can perform the processing related to the operation check based on the same operation check scenario. When the update program and the operation check scenario are output to the in-vehicle ECU 3 to be updated, the control unit 20 of the in-vehicle device 2 may also output an activation request indicating to apply the update program to the in-vehicle ECU 3 to be updated.

The control unit 20 of the in-vehicle device 2 outputs, to the in-vehicle ECU 3 to be updated, a request for shifting to the operation check mode (step S104). The in-vehicle ECU 3 to be updated that has obtained (received) the request for shifting to the operation check mode from the in-vehicle device 2 starts execution of the operation check based on the operation check scenario, prior to the update program being applied to the in-vehicle ECU 3 to be updated.

The control unit 20 of the in-vehicle device 2 outputs the operation check data to the in-vehicle ECU 3 to be updated, based on the operation check scenario (step S105). In the normal state (normal mode) such as the state in which the vehicle C is traveling, the target of data transmission by the in-vehicle ECU 3 to be updated is not the in-vehicle device 2, but another in-vehicle ECU 3. In contrast, in the operation check scenario, the in-vehicle device 2 substitutes for the other in-vehicle ECU 3 so as to simulate the operation mode of the other in-vehicle. With this configuration, the in-vehicle ECU 3 to be updated that is in the operation check mode executes a series of processing sequence including data transmission and reception with the in-vehicle device 2 that substitutes for the other in-vehicle ECU 3. The control unit 20 of the in-vehicle device 2 outputs the operation check data to the in-vehicle ECU 3 to be updated based on the operation check scenario, and thus the in-vehicle ECU 3 to be updated also outputs the response data based on the operation check scenario. In other words, the control unit 20 of the in-vehicle device 2 and the in-vehicle ECU 3 to be updated start data transmission and reception in accordance with the actual vehicle environment through the same operation check scenario.

The control unit 20 of the in-vehicle device 2 obtains the result of the operation check performed based on the operation check scenario (step S106). The in-vehicle ECU 3 to be updated outputs, to the in-vehicle device 2, the result of the stand-alone diagnosis and the result of the operation check related to the data transmission and reception for the operation check from the in-vehicle ECU 3 to be updated. The control unit 20 of the in-vehicle device 2 obtains these results from the in-vehicle ECU 3 to be updated. Furthermore, the control unit 20 of the in-vehicle device 2 obtains the result of the operation check regarding the transmission and reception of the operation check data from the in-vehicle device 2. As described above, in the operation check performed based on the operation check scenario, the various actual measurement values are stored in the storage unit 21 of the in-vehicle device 2. The control unit 20 of the in-vehicle device 2 obtains the result of the operation check related to the transmission and reception of the operation check data from the in-vehicle device 2 by referring to the storage unit 21. In other words, the control unit 20 of the in-vehicle device 2 obtains these three operation check results.

The control unit 20 of the in-vehicle device 2 determines whether or not the program update in the in-vehicle ECU 3 to be updated has succeeded (step S107). The operation check scenario includes determination information for determining the result of the operation check. The control unit 20 of the in-vehicle device 2 determines whether or not the program update has succeeded by comparing the various actual measurement values, which are the obtained results of the operation check, with the expectation values included in the determination information. When all the actually measured values are within the range of the expectation values, for example, the control unit 20 of the in-vehicle device 2 determines that the program update has succeeded. When any one of the actually measured values is not within the range of the expectation values, for example, the control unit 20 of the in-vehicle device 2 determines that the update of the program has failed.

When the program update has succeeded (YES in step S107), the control unit 20 of the in-vehicle device 2 requests the in-vehicle ECU 3 to be updated to shift to the normal mode (step S108). When it is determined that the program update has succeeded, the control unit 20 of the in-vehicle device 2 outputs a control signal (normal-mode shift signal) to the in-vehicle ECU 3 to be updated, for example, to request the in-vehicle ECU 3 to be updated to shift to the normal mode. The in-vehicle ECU 3 to be updated, which receives the request to shift to the normal mode, shifts to the normal mode.

If the program update has not succeeded (NO in step S107), that is, if the program update has failed, the control unit 20 of the in-vehicle device 2 requests the in-vehicle ECU 3 to be updated to perform rollback processing (step S1071). If it is determined that the update of the program has failed, the control unit 20 of the in-vehicle device 2 outputs a control signal (rollback signal) to the in-vehicle ECU 3 to be updated, for example, to request the in-vehicle ECU 3 to be updated to perform the rollback processing. The control unit 20 of the in-vehicle device 2 may also determine whether the in-vehicle ECU 3 to be updated performs the rollback processing or shifts to the degeneration mode, according to the aspect of the result of the operation check.

The control unit 20 of the in-vehicle device 2 outputs (transmits), to the program providing device S1, the result of the operation check performed based on the operation check scenario (step S109). The control unit 20 of the in-vehicle device 2 outputs (transmits) the result of the operation check performed based on the operation check scenario to the program providing device S1 via the vehicle-outside-communication device 1. Alternatively, the control unit 20 of the in-vehicle device 2 may also output the result of the operation check performed based on the operation check scenario to the display device 5, and notify the operator or the like of the vehicle C of the result.

According to the present embodiment, the in-vehicle ECU 3 to be updated and the in-vehicle device 2 perform the operation check of the in-vehicle ECU 3 to which the update program is applied (the in-vehicle ECU 3 to be updated) based on the same operation check scenario, and it is possible to efficiently check the operation of the in-vehicle ECU 3 in the actual environment of the vehicle C in which the in-vehicle ECU 3 and the in-vehicle device 2 are mounted. In the processing sequence of the operation check performed based on the operation check scenario, the in-vehicle device 2 substitutes for another in-vehicle ECU 3 other than the in-vehicle ECU 3 to be updated, and thus the in-vehicle ECU 3 to be updated can perform pseudo data transmission with the other in-vehicle ECU 3, and can efficiently perform the operation check according to the actual environment of the vehicle C.

### Second Embodiment

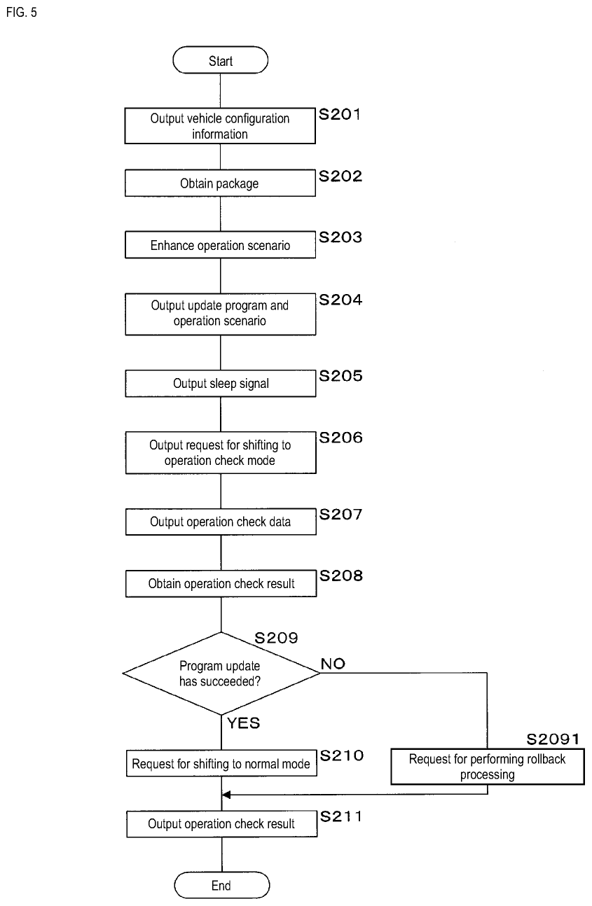

FIG. 5 is a flowchart illustrating processing performed by a control unit 20 of an in-vehicle device 2 according to a second embodiment. The control unit 20 of the in-vehicle device 2 outputs (transmits), to the program providing device S1, the vehicle configuration information of the vehicle C (the vehicle in which the in-vehicle device 2 is mounted) (step S201). The control unit 20 of the in-vehicle device 2 obtains, from the program providing device S1, the package including the update program and the operation check scenario (S202). The control unit 20 of the in-vehicle device 2 performs the processing of step S101 and step S102 in the same manner as the processing of step S201 and step S202 of the first embodiment.

The control unit 20 of the in-vehicle device 2 enhances the operation check scenario by using a relay log collected when the processing for relaying communication between the plurality of in-vehicle ECUs 3 is performed (step S203). The in-vehicle device 2 includes a plurality of vehicle-inside-communication units 23, and functions as an in-vehicle relay device that relays communication between the in-vehicle ECUs 3 connected vehicle-inside-communication communication units 23. The control unit 20 of the in-vehicle device 2 stores a relay log in the storage unit 21 based on the data (Ethernet frame or CAN message) that is relayed when relaying communication between the in-vehicle ECUs 3. The relay log includes, for example, header information (source address, destination address, message IDs, and so on), payload information, and transmission/reception frequency or cycle of Ethernet frames or CAN messages that are relayed, and indicates the communication state in the actual operation environment (actual vehicle environment) of the vehicle C in which the in-vehicle device 2 is mounted.

The control unit 20 of the in-vehicle device 2 adds or corrects the sequence related to data transmission and reception included in the operation check scenario using the relay log, for example, and enhances the operation check scenario created by the program providing device S1 so as to further conform to the actual vehicle environment. The control unit 20 of the in-vehicle device 2 performs the subsequent processing using the enhanced operation check scenario. In other words, in the subsequent processing, the operation check scenario to be used by the control unit 20 of the in-vehicle device 2 and the in-vehicle ECU 3 to be updated is the operation check scenario enhanced using the relay log.

The control unit 20 of the in-vehicle device 2 outputs, to the in-vehicle ECU 3 to be updated, the update program and the operation check scenario (step S204). The control unit 20 of the in-vehicle device 2 performs the processing of step S103 in the same manner as the processing of step S204 of the first embodiment.

The control unit 20 of the in-vehicle device 2 outputs a sleep signal to other in-vehicle ECUs 3 other than the in-vehicle ECU 3 to be updated (step S205). The control unit 20 of the in-vehicle device 2 can grasp the states of all the in-vehicle ECUs 3 mounted in the vehicle C by referring to, for example, the vehicle configuration information or a routing table that is used for the relay processing. The control unit 20 of the in-vehicle device 2 specifies the other in-vehicle ECUs 3 other than the in-vehicle ECU 3 to be updated among all the in-vehicle ECUs 3 mounted in the vehicle C. The control unit 20 of the in-vehicle device 2 outputs (transmits), to the specified other in-vehicle ECUs 3, a sleep signal for shifting to the sleep mode. The other in-vehicle ECUs 3 that have received the sleep signal shift to the sleep mode, and stop processing such as data transmission and reception. As a result, the program update process can be performed on the in-vehicle ECU 3 to be updated while preventing the program update process from affecting the other in-vehicle ECUs 3 other than the in-vehicle ECU 3 to be updated. The control unit 20 of the in-vehicle device 2 outputs a sleep signal, but the present disclosure is not limited thereto, and the control unit 20 of the in-vehicle device 2 may also restrict communication of the in-vehicle ECU 3 to be updated and the other in-vehicle ECUs 3 by stopping the relay processing in the in-vehicle device 2.

The control unit 20 of the in-vehicle device 2 outputs, to the in-vehicle ECU 3 to be updated, a request for shifting to the operation check mode (step S206). The control unit 20 of the in-vehicle device 2 outputs the operation check data to the in-vehicle ECU 3 to be updated, based on the operation check scenario (step S207). The control unit 20 of the in-vehicle device 2 obtains the result of the operation check performed based on the operation check scenario (step S208). The control unit 20 of the in-vehicle device 2 determines whether or not the program update in the in-vehicle ECU 3 to be updated has succeeded (step S209). If the program update has succeeded (YES in step S209), the control unit 20 of the in-vehicle device 2 requests the in-vehicle ECU 3 to be updated to shift to the normal mode (step S210). If the program update has not succeeded (NO in step S209), that is, if the program update has failed, the control unit 20 of the in-vehicle device 2 requests the in-vehicle ECU 3 to be updated to perform rollback processing (step S2091). The control unit 20 of the in-vehicle device 2 outputs (transmits), to the program providing device S1, the result of the operation check performed based on the operation check scenario (step S211). The control unit 20 of the in-vehicle device 2 performs the processing from step S104 to step S109 in the same manner as the processing from step S206 to step S211 in the first embodiment.

According to the present embodiment, the in-vehicle device 2 enhances the operation check scenario obtained from the external server through addition or the like by using the relay log collected at the time of performing the relay processing, for example, thereby improving the adaptability of the operation check scenario to the actual environment of the vehicle. By using the operation check scenario (enhanced operation check scenario) in which the adaptability with the actual environment of the vehicle is improved in this manner, it is possible to improve the accuracy of the operation check when the update program is applied to the in-vehicle ECU 3 to be updated.

The embodiments disclosed herein are exemplary in all respects, and should be construed as being not limitative. The scope of the present disclosure is indicated by the claims rather than by the foregoing description, and all changes which come within the meaning and range of equivalency of the claims are intended to be embraced therein.

1. An in-vehicle device that obtains an update program transmitted from an external server outside a vehicle and performs processing for updating a program of an in-vehicle ECU mounted in the vehicle, the in-vehicle update device comprising:
a control unit configured to perform processing related to the update program,
wherein the control unit
obtains, from the external server, an operation check scenario for performing operation check of an in-vehicle ECU to be updated when obtaining the update program,
outputs, to the in-vehicle ECU to be updated, the obtained update program and operation check scenario, and
performs processing related to the operation check of the in-vehicle ECU to be updated, based on the operation check scenario.

2. The in-vehicle device according to claim 1, wherein the control unit substitutes for another in-vehicle ECU other than the in-vehicle ECU to be updated, based on the operation check scenario, and performs processing related to the operation check of the in-vehicle ECU to be updated.

3. The in-vehicle device according to claim 2, wherein the operation check scenario includes:
a processing sequence in which the control unit that substitutes for the other in-vehicle ECU transmits data to the in-vehicle ECU to be updated, and
a processing sequence in which the in-vehicle ECU to be updated to which the update program is applied transmits data to the other in-vehicle ECU substituted by the control unit.

4. The in-vehicle device according to claim 1, wherein the operation check scenario includes determination information for determining a result of the operation check of the in-vehicle ECU to be updated, and
the control unit
performs processing related to an operation check of the in-vehicle ECU to be updated, and obtains a result of the operation check, and
determines whether or not the program update in the in-vehicle ECU to be updated has succeeded, based on the obtained result of the operation check and the determination information included in the operation check scenario.

5. The in-vehicle device according to claim 4, wherein the control unit,
obtains, from the in-vehicle ECU to be updated, a result of a stand-alone diagnosis performed by the in-vehicle ECU to be updated based on the operation check scenario, and
determines whether or not the program update in the in-vehicle ECU to be updated has succeeded, based on the obtained result of the stand-alone diagnosis.

6. The in-vehicle device according to claim 1, wherein the control unit:
enhances the operation check scenario obtained from the external server, using a relay log collected when a relay processing of communication between a plurality of in-vehicle ECUs mounted in the vehicle is performed,
outputs the obtained update program and the enhanced operation check scenario to the in-vehicle ECU to be updated, and
performs processing related to the operation check of the in-vehicle ECU to be updated, based on the enhanced operation check scenario.

7. The in-vehicle device according to claim 1, wherein, when an IG switch of the vehicle is turned off, the control unit performs processing related to the operation check of the in-vehicle ECU to be updated, based on the operation check scenario.

8. The in-vehicle device according to claim 1, wherein the control unit,
outputs, to the other in-vehicle ECUs other than the in-vehicle ECU to be updated, a sleep signal for transitioning to a sleep mode, and
performs, after outputting the sleep signal, processing related to the operation check for the in-vehicle ECU to be updated, based on the operation check scenario.

9. A program that causes a computer that obtains an update program transmitted from an external server outside a vehicle and performs processing for updating a program of an in-vehicle ECU mounted in the vehicle to execute processing for:
obtaining, from the external server, an operation check scenario for performing operation check of the in-vehicle ECU to be updated when obtaining the update program,
outputting, to the in-vehicle ECU to be updated, the obtained update program and operation check scenario, and
performing processing related to the operation check of the in-vehicle ECU to be updated, based on the operation check scenario.

10. A method for updating a program that causes a computer configured to obtains an update program transmitted from an external server outside a vehicle and performs processing for updating a program of an in-vehicle ECU mounted in the vehicle to execute processing for:
obtaining, from the external server, an operation check scenario for performing operation check of the in-vehicle ECU to be updated when obtaining the update program,
outputting, to the in-vehicle ECU to be updated, the obtained update program and operation check scenario, and
performing processing related to the operation check of the in-vehicle ECU to be updated, based on the operation check scenario.
